(19) United States
(12) Patent Application Publication
(10) Pub. No.: US 2004/0021117 A1
(43) Pub. Date: Feb. 5, 2004

(54) Valve system

(76) Inventor: John Edward Chapman, Kingston (AU)

Correspondence Address: Neil P. Ferraro, Wolf, Greenfield & Sacks, P.C., Federal Reserve Plaza, 600 Atlantic Avenue, Boston, MA, 02210, US

(21) Appl. No.: 10/441,477

(22) Filed: May 20, 2003

Related U.S. Application Data
(63) Continuation of application No. PCT/AU01/01504, filed on Nov. 20, 2001.

(30) Foreign Application Priority Data
Nov. 20, 2000 (AU) PR1581

(51) Int. Cl. F16K 1/16

(52) U.S. Cl. 251/298

(57) ABSTRACT

The present invention provides a valve system comprising a valve body having at least a first port and a second port; a valve member located within said valve body and operably movable between a first position at which said first port is sealed and a second position in which said first port is fully open; and an operating mechanism for moving the valve member between the first and second positions. The operating mechanism is adapted to be mounted adjacent the valve body and includes a transmission member operatively connected with the valve member, and a rotary actuator operable to effect movement of the transmission member. The operating mechanism is such that rotary movement of the actuator member effects independent linear and rotational movements of the transmission member causing corresponding linear and rotational movements of the valve member moving it from the first position to the second position. The transmission member and actuator member are desirably located within a housing mounted adjacent the valve body. The movement of the valve member from the first position to the second position typically comprises an initial linear movement of the valve member out of sealed engagement at the first port, followed by rotational movement. The rotational movement of the valve member is preferably through an angle of approximately 90 degrees.

### FIELD OF THE INVENTION

The present invention relates to a valve system, and in particular to a valve system which has application as a diversion valve or a clear bore valve for use in the control of gas, liquid and/or semi-solid fluid streams.

### BACKGROUND ART

Generally, valves that are to be used in gas streams are required to provide an efficient seal to prevent gas leakage. Often valves that are used in both gas and liquid systems include a leaf valve or a plate valve. Such valves usually involve a simple one step action to move the valve from a closed position to an open position. In the case of a plate valve, such movement is usually a rotational movement wherein the plate is associated with a shaft and rotation of the shaft causes rotation of the plate.

In order to ensure an adequate seal, O rings or other such seals are either positioned around the plate or the valve disc to ensure an adequate seal. In time, however, such seals may wear, or alternatively simply fail to seal the valve adequately due to the imprecise nature of the valve.

As an alternative, a flange or valve seat may be associated with a pipe or channel through which the gas or other fluid flows. The valve seat assists in the sealing of the valve by abutting against the valve plate when in a closed position. Again, the effectiveness of such sealing may be inhibited given the imprecise positioning of the valve plate relative to the valve seat, and it may fail to provide a positive seal for the fluid stream.

Australian Patent 671425 in the name of John Edward Chapman describes a butterfly valve system that allows for both linrear and rotational movement of a valve plate in order to effect improved sealing. This arrangement has the disadvantage, however, that the valve plate and at least part of the operating mechanism are permanently located in the flow path, and therefore always at least partially obscure the flow path when the valve is open.

Other valve systems are able to impart both rotational and linear movement to the valve plate, such as in French Patent 1,184,986. However, the valve system disclosed in that specification relies upon a ball dentate system to rotate a cam within the mounting. As such, a high degree of tolerance is required within the spring, and the valve system is unable to cope with various stresses such as heat.

Generally, the valves described above are operable in a linear pipe system and do not divert the flow of gas or liquids to other streams. A typical manner in which valves are used in order to divert the flow of a gas or liquid stream is to individually seal a pipe entrance while opening another. This involves the use of at least two valve systems.

The above discussion of background art is included in this specification solely for the purpose of providing a context for the present invention. It is not suggested or represented that any or all of that material forms part of the prior art base or common general knowledge in the field relevant to the present invention as it existed in Australia before the priority date of this application.

It is an object of the present invention to overcome or at least alleviate one or more of the difficulties associated with the prior art discussed above.

### SUMMARY OF THE INVENTION

Broadly, the present invention provides a valve system comprising: a valve body having at least a first port and a second port; a valve member located within said valve body and operably movable between a first position at which a part of the valve member seals said first port, and a second position in which said first port is fully open and unobscured by said valve member part; and an operating mechanism for moving the valve member between the first and second positions.

The operating mechanism is adapted to be mounted adjacent the valve body and includes a transmission member operatively connected with the valve member, and a rotary actuator operable to effect movement of the transmission member. The operating mechanism is such that rotary movement of the actuator member effects independent linear and rotational movements of the transmission member causing corresponding linear and rotational movements of the valve member moving it from the first position to the second position. The transmission member and actuator member are desirably located within a housing mounted adjacent the valve body.

The movement of the valve member from the first position to the second position typically comprises an initial linear movement of the valve member out of sealed engagement at the first port, followed by a rotational movement. The rotational movement of the valve member is preferably through an angle of approximately 90 degrees.

In a preferred embodiment of the invention, the transmission member has one or more shaped portions at its periphery for interaction with one or more abutment surfaces at the inner sides of the housing. The linear movement of the transmission member, upon rotary movement of the actuator, results from reaction forces between the shaped portion(s) of the transmission member and the abutment surface(s) within the housing.

Preferably, the abutment surfaces at the inner sides of the housing include a surface presented by a first inwardly projecting element. The shaped portions at the periphery of the transmission member preferably include a recess or shoulder, which receives or abuts that first projecting element when the valve member is in the first position. This provides an interaction between the transmission member and the housing which constrains the initial movement of the transmission member, and thus of the valve member, to a linear movement as it begins to move from the first position.

Furthermore, the abutment surfaces preferably include a surface presented by a second inwardly projecting element, and the recess or shoulder on the transmission member is designed to receive or abut that second projecting element when the valve member is in the second position.

Preferably, a recess in the transmission member is able to be received over an abutment element in a key-and-slot arrangement. This key-and-slot arrangement helps to prevent rotation of the transmission member when the valve member is being released by linear movement, and to prevent premature linear movement when the valve member is being rotated to the second position. The shape of the inner surface of the housing also generally dictates the linear and/or rotational movement of the transmission member. This shape may be varied in accordance with desired movement patterns of the valve member.

In a preferred embodiment of the invention, the actuator member and the transmission member are each formed from flat, plate material, and lie adjacent one another within the operating mechanism housing for movement in substantially parallel planes. The transmission member is preferably rigidly connected to the valve member at one side thereof. The other side of the transmission member has a pin protrusion. The actuator member has a hole or aperture within which that pin protrusion is received. The inner sides of that hole or aperture may therefore operably engage the pin protrusion to move the transmission member, and thus the valve member, between the first and second positions. The pin-receiving hole or aperture in the actuator member is preferably designed substantially larger than the pin protrusion itself. This provides the actuator member with a degree of ‘play’ or room for rotary movement without causing movement of the transmission member. This ‘play’ enables the actuator member to strike the transmission member pin with a hammer action. The actuator member is preferably mounted on a shaft, and rotary motion is preferably imparted to it by means of that shaft.

Thus, the actuator member or ‘rotor’ may have some free rotary movement before the rotor impacts upon the transmission member pin. This allows the rotor, which may be pneumatically operated, to have a hammer action which can assists in initially releasing the valve from the valve seat. The positioning and interaction of the abutment surfaces and shaped portions of the transmission member define this initial linear movement of the transmission member away from the valve seat. Once the valve member has been released from the valve seat, the pressure within the valve normalises allowing for rapid free rotation of the rotor allowing for ease of movement of the valve to the second position, at which the first port is then fully open.

Preferably, the housing of the operating mechanism is mounted directly to the valve body, for example by bolts, by welding or other such means, and defines a substantially circular cavity within which the actuator and transmission members reside.

Furthermore, the transmission member and the actuator member are preferably constructed from a tough and hardened material such as steel or the like. The shape of the transmission member and its interaction with the abutment surfaces inside the housing allow for both linear and rotational movement of the transmission member. This in turn corresponds to both linear and rotational movement of the valve member. The abutment surfaces within the housing may be formed by separate elements or may be formed integrally with the housing. Any such elements, and the housing itself, are also preferably constructed from a hardened steel. As already noted, the housing abutment surfaces preferably include the surfaces of two inwardly projecting elements, positioned angularly offset by about 90° from each other at the internal surface of the housing.

Advantageously, the present invention is able to provide a valve system which has the benefits of reliable sealing by virtue of the independent linear and rotational movement of the valve member, and which furthermore has the benefit of the operating mechanism being separate from or external to the valve body. With the operating mechanism mounted adjacent the valve body, it does not impinge upon or obscure the flow of fluid through the valve. Accordingly, the first port of the valve body is desirably fully unobscured when the valve member is in the second position. A more complete understanding of these advantages will be apparent from the following description of particularly preferred embodiments.

In one particularly preferred embodiment, the valve system of the invention is a diversion valve, which is operable to selectively divert a fluid flow from one pipeline route to an alternative pipeline route. Accordingly, the valve system is adapted to direct fluid entering the valve body at an inlet to one of two separate outlets.

In this particular embodiment, therefore, each of the first and second ports of the valve body are outlet ports, and the valve body includes a third inlet port via which the fluid enters the valve system. The valve member is movable between the first and second positions to divert flow from the inlet port of the valve body to either one of the second or first outlet ports, respectively. That is, when the valve member is in the first position, the first outlet port is sealed and fluid is free to flow from the inlet port through the valve body and away through the second outlet port. When the valve member is in the second position, the second outlet port is sealed, and the fluid is free to flow from the inlet port through the valve body and away through the first outlet port.

In this embodiment, movement of the valve member from the first position to the second position comprises an initial linear movement of the valve member out of sealed engagement at the first port, followed by a rotational movement of the valve member to align it with the second port and then a further linear movement into sealed engagement at the second port. The reverse applies as the valve member moves from the second position to the first position.

The valve member preferably includes a disc-shaped plug for sealing against a valve seat at each of the first and second outlet ports in the first and second positions, respectively. However, any other appropriately shaped sealing element, such as a ball or cone, could also be used. The disc-shaped plug is preferably constructed of a semi-rigid plastic material, but may also be made of any other appropriate material. Semi rigid plastic material allows for some compression upon sealing.

The valve seat at each of the first and second outlet ports preferably includes a circular bevelled edge. In other words, the valve seat may be angled slightly so that the valve plug is actually forced into a slightly truncated conical recess. If a rigid material is used to form the valve member, O-rings or other resilient sealing means may surround either the valve member or the valve seat to assist sealing. Preferably, an O-ring resides within an annular groove around an outer periphery of the disc-shaped plug. The linear movement of the valve member forces the plug into the angled valve seat providing a positive seal against it. This also allows the valve member to be “self centering” within the valve seat as a result of the flexibility provided by the O rings. The valve member may be bevelled or shaped toward the outer circumference of the plug, to assist in forming a positive seal at the valve seat. The valve member may also naturally take any shape that is going to fit positively within the valve seat.

In this diversion valve embodiment, the valve member preferably includes a stem with a 90° elbow that extends from the plug into the housing of the operating mechanism where it is connected to the transmission member. Preferably, it is connected by way of screws, but it may alternatively be welded or integrally formed with the transmission member.

The diversion valve system of the invention is particularly applicable for use in pipe systems where it is desired to control a diversion of a gas or liquid stream from a pipe running in a first direction to a pipe running at approximately 90° to the first pipe. That is, the diversion valve of the invention is particularly suited to a “Tee” junction of three pipes, one of which joins the valve body at the inlet port, and the other two of which join the valve body at the first and second outlet ports. The first outlet port is typically substantially aligned with the inlet port, and the second outlet port is arranged at approximately 90° to the first outlet port. The valve member is located within a cavity or chamber of the valve body that forms the junction between a plurality of pipes.

Diversion of the flow is achieved by moving the valve member through approximately 90°. The extent to which the valve member moves is dependent upon the movement of the transmission member. As will become more evident later, the rotation of the transmission member is dependent upon the shape of the transmission member, and the positioning of the abutment elements. Movements of less or more than 90° can be achieved by appropriate positioning of the abutment elements and alignment of the flat edges of the transmission member.

It is also contemplated that a diversion valve system according to the present invention could be designed in which the valve member moves in a step like fashion. That is, the valve member could undergo linear and rotational movement from a first position to seal a second port, and then undergo further linear and rotational movement to seal a third port.

In an alternative particularly preferred embodiment of the invention, the valve system of the invention is a clear bore valve, which is operable to selectively open or close a passage for fluid flow in a pipeline. This particular embodiment is especially suitable for applications involving the flow of viscous or semi solid material (such as a slurry) through a pipeline. Accordingly, in this particular embodiment, the first and second ports of the valve body preferably correspond to outlet and inlet ports, respectively. In the first position, the valve member seals the first port (ie outlet port). In moving from the first position to the second position, the valve member undergoes an initial linear movement corresponding to the movement of the transmission member, to unseat the valve member, followed by rotational movement to fully open the valve. In reverse, the valve member undergoes rotational movement and then linear movement to seal the valve. Thus, in the second position, the first port (ie the outlet port) is fully open, with the valve member providing fluid communication between the inlet port (ie the second port) and the outlet port.

The valve member preferably includes a closed or blind face for sealing against a valve seat at the outlet port when the valve member is in the first position. The valve member furthermore preferably includes an open pipe segment adapted to provide fluid communication between the first (ie outlet) port and the second (ie inlet) port when the valve member is in the second position. The open pipe segment has substantially the same dimensions as the flow openings of the inlet and outlet ports.

In this embodiment, the transmission member may have a cut away shoulder section adapted to abut with projecting elements in the housing. In this embodiment, when moving from the first position to the second position, the transmission member undergoes linear movement to disengage the shoulder from a first projecting element in the housing. This corresponds to a linear movement of the valve member as it disengages from the valve seat. Subsequent rotation of the transmission member and the corresponding rotation of the valve member results in the shoulder engaging with a second projecting element which forms a stop. Accordingly, there is no need for a further linear movement. At this point, the valve system is in a fully open position with the valve member providing an unobstructed, flow through pipe.

In a preferred embodiment of the present invention, the valve system further includes a locking mechanism to lock the valve member in a mid-position between the first and second positions. In the case of a diversion valve, for example, this would result in both of the first and second outlet ports (as well as the inlet port) being locked open, thereby allowing fluid flow through both of the outlet pipes.

The locking means preferably includes a movable locking pin which is held within a boss on the operating mechanism housing. The locking pin is biased (eg by a compression spring) into contact with the transmission member, and a slot is provided in said transmission member for receiving the locking pin. The locking pin is designed to enter the slot and to thereby lock the transmission member against further movement. The locking slot in the transmission member may be the same as a recess adapted to engage with the abutment surfaces, but is more preferably a separate slot located in a distinct segment of the transmission member.

The locking mechanism furthermore preferably includes disabling means adapted to selectively hold the locking pin in a retracted state to prevent it from entering the locking slot in the transmission member. The disabling means is preferably able to be hand operated to retract and fix the pin against the bias of the compression spring.

Alternatively, the locking means may include a double acting pneumatic cylinder for activating engagement and disengagement of the locking pin within the slot within the transmission member.

The above features and advantages of the present invention will be more fully appreciated from the following detailed description of preferred embodiments of the invention, with reference to the accompanying drawings.

### BRIEF DESCRIPTION OF THE DRAWINGS

Preferred embodiments of the invention are hereafter described with reference to the accompanying drawings, which are intended to be illustrative of the invention only, in which like reference numerals designate like features, and in which:

FIG. 1 is a sectional top view of a diversion valve system in accordance with the invention showing the operating mechanism when the valve member is in a first position sealing a first outlet port;

FIG. 2 is a sectioned side view of the valve of FIG. 1 in the direction of arrows II-II, in the same position and showing the valve member sealing against the first outlet port;

FIG. 3 is a sectional top view of the valve of FIG. 1 after the valve has undergone initial linear movement to release the seal at the first port;

FIG. 4 is a sectioned side view in the direction of arrows IV-IV in FIG. 3;

FIG. 5 is a sectional top view of the valve of FIG. 1 mid-way through its rotational movement between the first seal position and the second position;

FIG. 6 is a sectional top view of the valve of FIG. 1 after the valve member has been rotated into alignment with the second outlet port;

FIG. 7 is a sectional top view of the valve of FIG. 1 when the valve member is in the second position sealing the second outlet port;

FIG. 8 is an exploded view of the diversion valve system in accordance with the invention;

FIG. 9 is a sectional top view of the diversion valve system in accordance with the invention showing detail of a locking mechanism;

FIG. 10 shows detail of an alternative pneumatic locking mechanism;

FIGS. 11a and 11b show perspective views of the operating mechanism (with valve member attached) and the valve body, respectively, of a the diversion valve system in accordance with the invention;

FIG. 12 is a sectional top view of an alternative embodiment of a diversion valve in accordance with the invention together showing the operating mechanism after the valve member has undergone initial linear movement to release the seal at the first outlet port;

FIG. 13 is a sectioned side view in the direction of arrows A-A in FIG. 12;

FIG. 14 is a sectional top view of a clear bore valve embodiment in accordance with the invention showing the operating mechanism after the valve member has undergone initial linear movement from the first position to release the seal at the first port;

FIG. 15 is a sectioned side view in the direction of arrows B-B in FIG. 14;

FIG. 16 is a sectioned side view in the direction of arrows C-C in FIG. 14

FIG. 17 is a sectional top view of the clear bore valve of FIG. 14 approx. mid-way through its rotational movement between the first position and the second position;

FIG. 18 is a sectional top view of the valve of FIG. 14 with the valve member rotated to the second position so that the first outlet port (and hence the valve) is fully open; and

FIG. 19 is a sectioned side view in the direction of arrows D-D in FIG. 18.

### DETAILED DESCRIPTION OF THE PREFERRED EMBODIMENTS

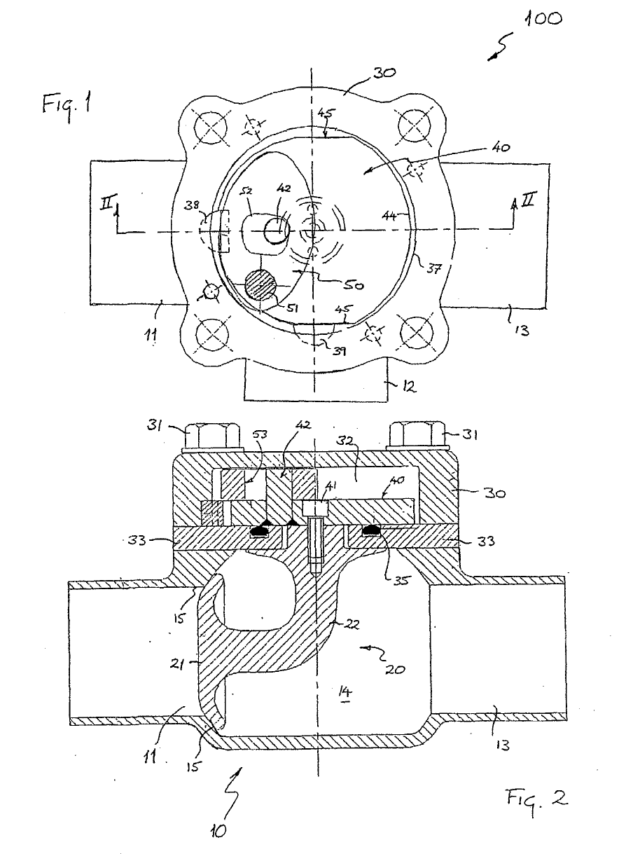

Referring firstly to FIG. 1 and FIG. 2 of the drawings, a particularly preferred embodiment of the present invention provides a diversion valve system 100 comprising a valve body 10 forming a “T”-junction for a pipe network. The valve body 10 may be formed from any suitable material (such as steel, brass, plastics etc.) and includes a first outlet port 11, a second outlet port 12 and an inlet port 13.

The valve system 100 further includes a valve member 20 located within the valve body 10 in a chamber 14 that communicates with each of the inlet and outlet ports. The valve member 20 has a disc-shaped plug 21 which in FIG. 2 is shown in a first position sealed against a valve seat 15 of the first outlet port 11. The plug 21 is winged slightly to seal properly within the slightly bevelled valve seat 15. A tight seal is achieved if the plug is made of a slightly deformable semi rigid plastics material. If a more rigid material is used, however, the valve seat or valve plug may include an O-ring.

The valve member 20 further includes a stem 22 having a 90° elbow that extends from the disc-shaped plug 21 to an operating mechanism for moving the valve member to divert flow from the inlet port 13 to either one of the first and second outlet ports 11,12. Accordingly, the valve member 20 is operably moveable between the first position at which it seals the first outlet port 11 and a second position in which it seals the second outlet port 12, leaving the first outlet port 11 fully open.

The operating mechanism for moving the valve member 20 between the first and second positions includes a housing 30 which is mounted to the exterior of the valve body 10 by means of bolts 31. The housing 30 defines a cavity 32 having a substantially circular cross-section (as seen in FIG. 1). Within the housing cavity 32, the operating mechanism includes a plate-like transmission member 40, which is rigidly connected to the stem 22 of the valve member 20 by means of screws 41. A base plate 33 of the housing forms a cover for the valve body 10 and a boss 23 at the end of the valve member stem 22 extends through a central opening 34 in that base plate for connection with the transmission member 40. An O-ring 35 is disposed in a groove 36 to provide a seal between the base plate 33 and the transmission member 40. The base plate 33 provides a surface for the transmission member to move upon. Protruding from the other side of the plate-like transmission member 40 is a stub or pin 42.

The operating mechanism of the valve system 100 further includes an oval-shaped actuator member 50 which lies next to the transmission member 40 within the housing 30. The actuator member is mounted on a shaft 51 for rotary movement about the axis about that shaft. This rotary actuator (also known as a “rotor”) has a hole or aperture 52 formed through it, within which the pin protrusion 42 from the transmission member 40 is received. The hole or aperture 52 is substantially larger that the pin protrusion 42, providing a degree of ‘play’ or free movement between sides 53 of the hole and the pin.

The operating mechanism is such that rotary movement of the actuator member 50, which may be generated manually or automatically by rotation of the shaft 51, is adapted to impart or effect independent linear and rotational movement of the transmission member. This in turn causes corresponding linear and rotational movement of the valve member 20 to move it between the first and second positions.

In this regard, the sides 53 of the hole or aperture 52 operably engage the pin protrusion 42 as the actuator member 50 rotates to move the transmission member 40. The actual movement of the transmission member 40 is dictated by the interaction between various shaped portions at the outer periphery of the transmission member, and various abutment surfaces around the inner sides of the housing. The shaped portions at the periphery of the transmission member 40 include curved portions 44, flattened portions 45 and a substantially rectangular recess 46. The abutment surfaces inside the housing 30 for interaction with the shaped portions 44, 45, 46 of the transmission member include the inside surface of the walls 37 of the housing itself as well as surfaces presented by two inwardly projecting abutment elements 38, 39. These abutment elements 38, 39 may be integrally formed with the walls 37 of the housing, or they may be separate inserts. In any case, they are fixed in place and are particularly adapted to cooperate with the substantially rectangular recess 46 in the transmission member.

Considering movement of the valve member 20 initiating from the first position as shown in FIGS. 1 and 2, the actuator member 50 is rotated in a clockwise direction. The substantially larger size of the hole 52 compared with the size of the protrusion pin 42 means that the actuator member 50 initially strikes the protrusion pin with a hammer action. As it does so, movement is imparted to the transmission member 40. At that moment, the abutment surface of the projecting elements 38 interacts with the recess 46, and the flattened portion 45 slides on the other projecting element 37, to initially constrain the movement of the transmission member 40 to a linear displacement, from left to right as seen in FIG. 1. This movement is transmitted directly to the valve member 20, which moves to the position shown in FIG. 4 at which the seal of the plug 21 at the valve seat 5 is released. The transmission member 40 moves in this linear direction away from the first abutment element 38, until it is prevented from further movement by the internal surface 37 of the housing 30. The sides 53 of the hole 52 slide relative to the transmission member pin 42 to assist this movement.

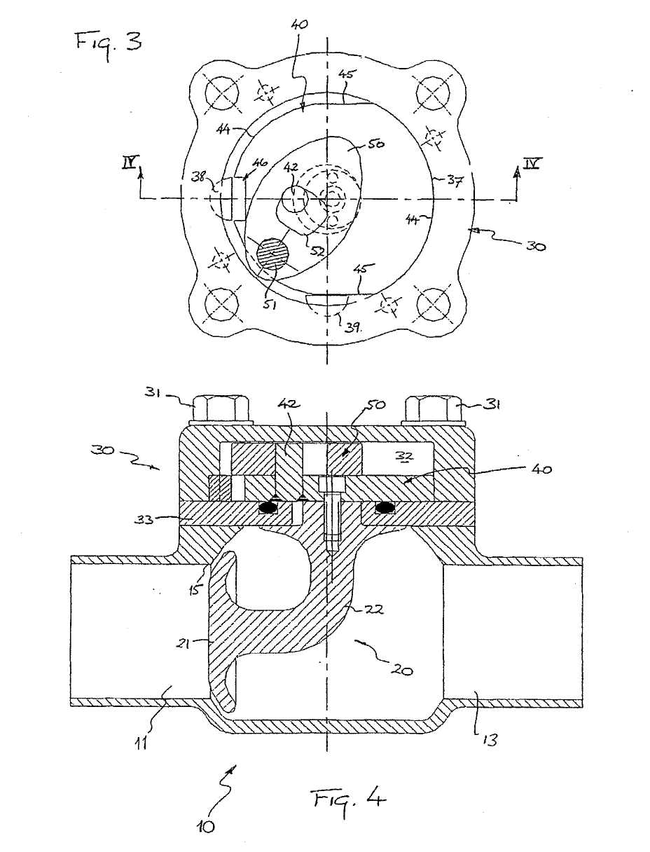

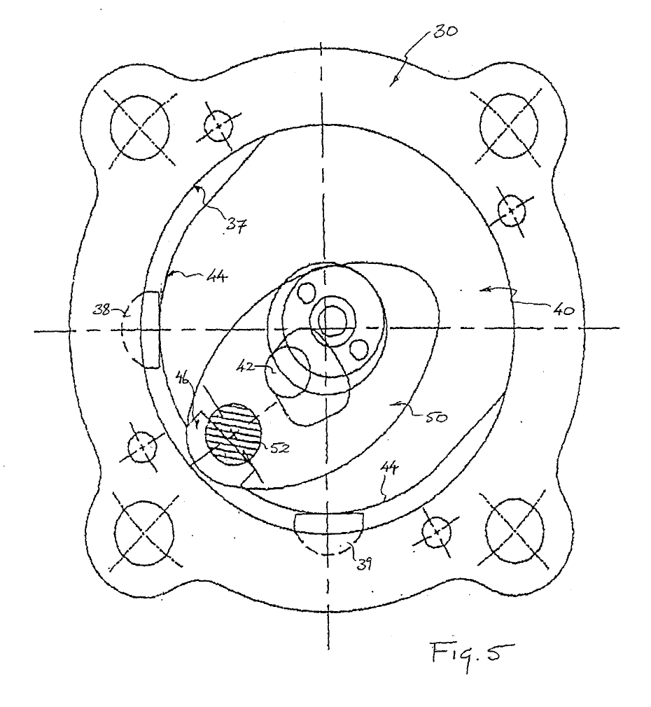

When the actuator rotor 50 reaches the position shown in FIG. 3 and FIG. 4, the rectangular recess 46 of the transmission member 40 disengages from the first abutment element 38 allowing the transmission member to undergo subsequent rotational movement. That is, the recess 46 in the transmission member 40 is free of the rotational constraints imparted by the projecting element 38 at the side of the housing 31. Because the seal of the valve member 20 at the valve seat 15 has been released, the pressure between the valve ports is now normalised. This therefore allows for free rotation of the transmission member 40 and the valve member 20. During rotation, the abutment elements 38, 39 now act against the rounded shaped surfaces 44 of the transmission member as illustrated in FIG. 5. This, together with the rounded internal surfaces of the housing walls 37, sees the transmission member 40 rotate counter to the direction of rotation of the rotor. FIGS. 5 to 7 show the relative positions of the transmission member 40, the actuator member 50 and the housing abutment elements 38, 39 as the actuator member 50 continues to rotate. After the initial linear movement of the transmission member causing the corresponding linear movement to disengage the valve member 20 from the valve seat 5, the further rotary movement of the actuator member in the clockwise direction generates a counter clockwise rotation of the transmission member 40.

Rotational movement of the transmission member 40 continues until such time as the flat surface of the first abutment element 38 comes into contact with the flattened portion 45 at the periphery of the transmission member. At this time, further force applied by the rotor 50 to the transmission member causes the transmission member to move in a linear direction toward the second abutment element (9). Accordingly, after approximately 90° angular rotation of the transmission member, the recess 46 and flat portions 45 at the periphery of the transmission member 40 again interact with the abutment surfaces of the projecting elements 38, 39 fixed at the sides of the housing 30 to constrain the transmission member to linear movement.

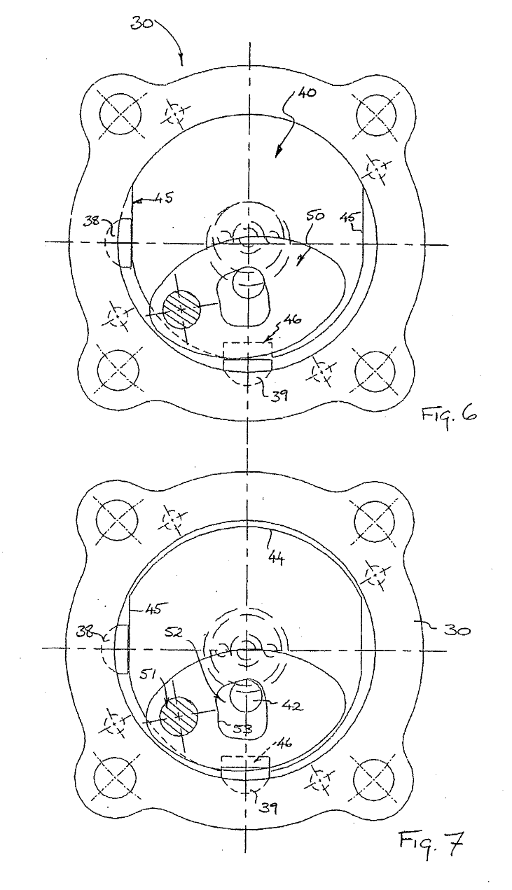

At the position of the transmission member 40 shown in FIG. 6, the valve member 20 has rotated through approximately 90° to be in alignment with the second outlet port. The final few degrees of rotation of the actuator member 50 between the position illustrated in FIG. 6 and the position illustrated in FIG. 7 generate another linear displacement of the transmission member. This corresponds to a linear movement of the valve member 20 into the second position, where it sealing engagement with the valve seat at the second outlet port 12. In this second position, the first outlet port 11 is fully open and the second outlet port 12 is sealed by the disc-shaped plug 21 of the valve member.

The corresponding movement of the transmission member 40 and the valve member 20 applies in reverse. Notably, the drawings illustrate a transmission member and valve member angular movement of 90°. It will be appreciated, however, that with appropriate positioning of the abutment elements, and shaping of the transmission member, other ranges of rotational and linear movements are possible.

FIG. 8 shows an exploded view of the various elements of the diversion valve system 100 of the present invention. Amongst these is a locking mechanism 60 which has hitherto not been previously described. This locking mechanism 60 includes a moveable locking pin 61 which resides within a cylindrical boss 62 which is mounted at the side of the housing 30 by a threaded fastening.

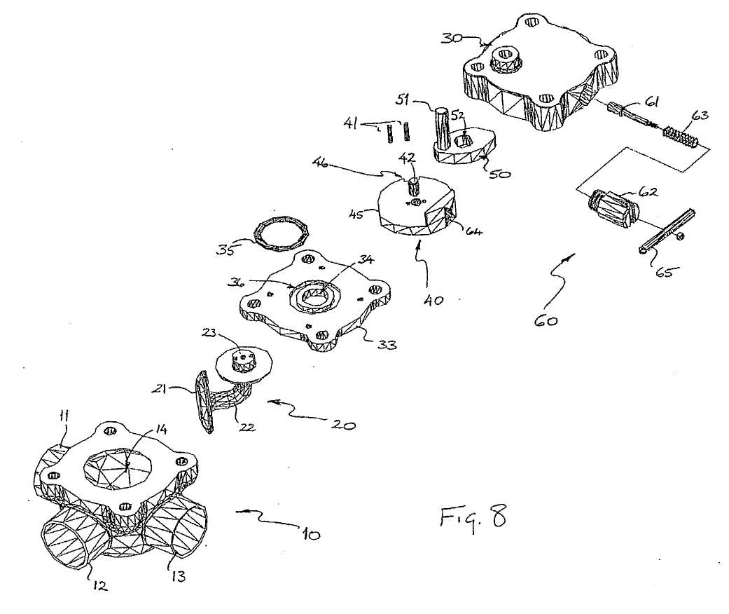

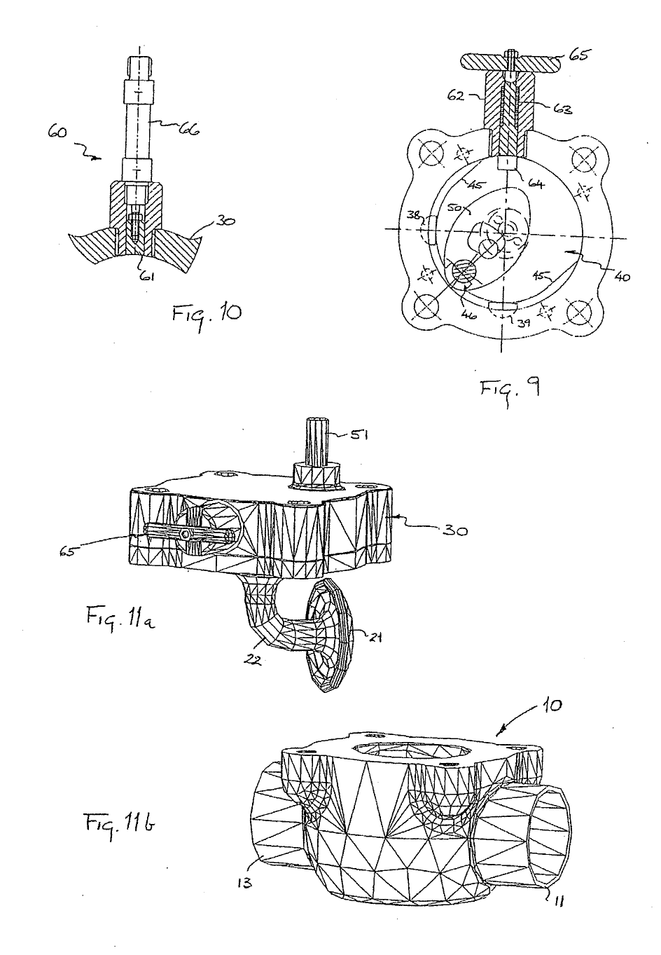

This locking mechanism arrangement is perhaps more clearly illustrated in FIG. 9. The locking mechanism 60 includes a compression spring 63 which biases the locking pin 61 to engage the periphery of the transmission member 40 The transmission 40 includes a slot or notch 64, which is adapted to receive the locking pin 61. As the movement of the transmission member 40 by the actuator member 50 brings the slot or notch 64 into alignment with the locking pin 61, the spring bias on the locking pin drives the pin into the slot 64 to fix the transmission member against further rotation. This fixes the valve member 20 approximately mid-way between the first and second positions, so that both the first and second outlet ports 11,12 are fully open. A small rod 65 may be fastened at an end of the locking pin 61 to provide means for disabling the locking mechanism 60. This rod 65 may be used to retract the locking pin 61 and to hold the locking pin in its retracted position, thereby preventing its ability to enter the slot 64 and interfere with the movement of the transmission member 40. Enabling and/or disabling of the locking mechanism 60 can be affected by simply rotating this rod 65 through a 90° angle. In its horizontal disposition, as shown in FIG. 9 and FIG. 11a, the locking pin 61 is held in its retracted position. When the rod 65 is in a vertical position, the locking pin 61 is able to engage the slot 64.

FIG. 10 shows an alternative embodiment for the locking mechanism 60 comprising a pneumatic actuator 66 able to engage and release the locking pin 61 into the locking slot 64.

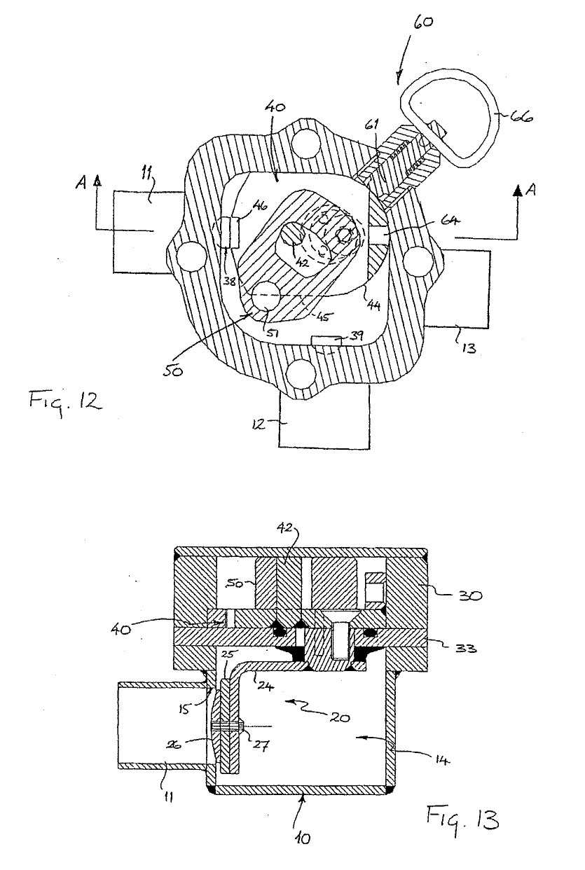

Referring to FIGS. 12 and 13 of the drawings, a slightly different diversion valve system 100 according to the invention is illustrated. In this case, the actuator member 50 has a substantially different configuration, as does the transmission member 40. This allows for substantially more free rotation of the transmission member. Nevertheless, the fundamental operation of these members remains substantially unaltered.

As can be seen in FIG. 13, the valve member 20 also has a substantially different configuration. The valve member comprises a bracket 24, a gasket 25 and a retaining washer 26. The gasket 25 may be made of either a solid or resilient material, but is preferably constituted of a high density material. In use, both the gasket 25 and the retaining washer 26 may be replaced. They are joined to the bracket by a bolt 27. The valve is sealed in the first and second positions when the gasket abuts straight faced against the first and second outlet ports 11,12, respectively. The seal will be tight due to the linear movement of the valve plug forcing the gasket against the port.

The inlet port 13 in the embodiment of FIGS. 12 and 13 is also somewhat offset from the first outlet port 11 compared to the configuration of the valve body 10 shown in FIG. 1. This offset configuration is designed to deflect flow more evenly to both outlet ports 11,12 when the transmission member 40 is locked in a mid-way position by the locking mechanism 60 to leave both of the first and second outlet ports fully opened and unobstructed. In FIG. 12, the rod 65 of the locking mechanism 60 is replaced by a D-ring 66 for easier grasping by a user's finger. Its function remains unchanged, however.

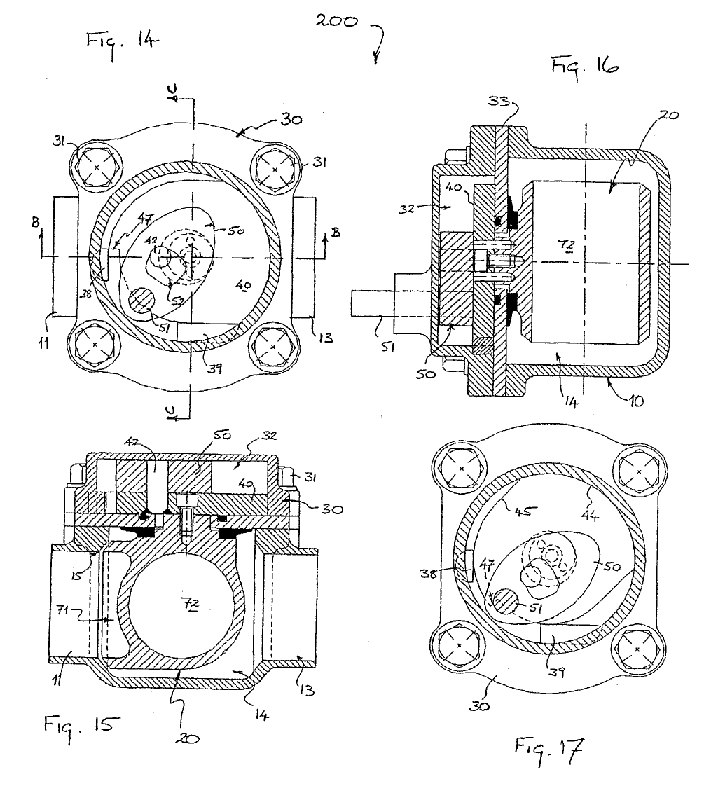

Referring now to FIGS. 14-19 of the drawings, an alternative particularly preferred embodiment of the present invention provides a clear bore valve system 200. Many of the features of this clear bore valve system 200 are the same as for the diversion valve system 100 described previously. In this regard, like reference numerals generally designate like features. One of the primary differences, however, is that the valve body 10 for this clear bore valve system 200 has only two ports, namely a first outlet port 11 and an inlet port 13.

Furthermore, the valve member 20 is designed to seal the outlet port 11 when it is in the first position, and is adapted to fully open the valve providing fluid communication between the inlet and outlet ports 11,13 when it is in the second position. Very clearly, the valve member 20 itself is substantially different compared to the previous diversion valve system embodiments. In this case the valve member 20 has a closed or blind face 71 for sealing against the bevelled valve seat 15 at the outlet port 11 when the valve member 20 is in the first position. The valve member furthermore includes an open pipe segment 72 which is adapted to provide fluid communication between the outlet port 11 and the inlet port 12 when the valve member is in the second position. The open pipe segment 72 has substantially the same dimensions as the flow openings of the inlet and outlet ports.

Again considering movement of the valve member 20 beginning from the first position, the actuator member 50 can strike the pin 42 of the transmission member 40 with a hammer action to initiate movement. As shown in FIG. 14, in this embodiment the transmission member 40 does not include a rectangular recess 46. In this case, it has a cut away section defining a shoulder 47, which is adapted to interact with the abutment surfaces of the projecting elements 38, 39. That shoulder 47 and the projecting element 38 together constrain the initial movement of the transmission member 40, and therefore of the valve member 20, to a linear displacement from left to right (seen in FIG. 14) to deseat the valve member 20 from the first outlet port 11.

FIGS. 14, 15 and 16 show various views of the clear bore valve system 200 after the initial linear movement of the valve member 20 from its first position sealing the first outlet port 11.

Once the valve member 20 has been released, the pressure between ports is normalised allowing rapid free rotation of the transmission member 40, which in turn enables a rapid free rotation of the valve member 20. This minimises, and in fact substantially eliminates, the potential for leakage at the valve seat, which in turn reduces any wearing of the valve. Furthermore, the free rotation of the actuator member enables the use of pneumatic devices to drive the movement of the actuator member.

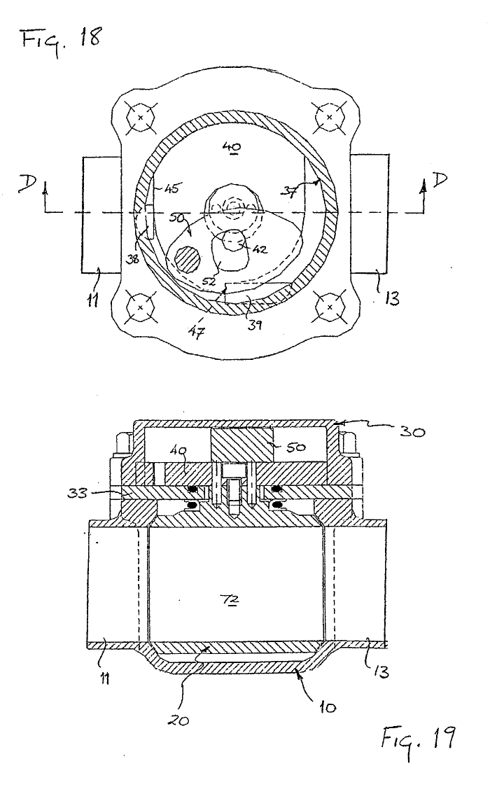

FIG. 17 shows the position of the transmission member 40 approximately mid-way through the rotary movement of the actuator member 50. When the actuator member reaches the full extent of its rotary motion on the shaft 51, the shoulder 47 comes to a stop in the second position against the end of the projecting element 39 (see FIG. 18). Accordingly, in this form of the invention there is no final linear movement in moving the valve member into the second position. The valve member 20 of this clear bore valve system 200 is shown in the second position in FIG. 19 providing unobstructed fully open fluid communication between the inlet port 13 and the outlet port 11.

The valve system of the present invention allows for improved sealing in a conduit system where with a single simple rotation movement, a valve plug can be moved at right angles from sealing a first port to sealing a second port. This will direct the flow of gas or liquid to a corresponding conduit. A positive seal is gained by the linear movement of the valve plug to seat firmly within the valve seat. Alternatively, the valve system of the invention can provide an improved clear bore valve system, with quick opening and quick movement of the valve member. Lubrication within the housing of the operating mechanism between the moving members of the valve system of this invention will typically enhance operation.

It will be understood that various alterations and/or additions may be introduced into the particular construction and arrangement of the valve parts specifically described without departing from the spirit of the invention as outlined herein.

Finally, it will also be understood that throughout the description and claims of this specification the word “comprise” and variations of that word, such as comprising and “comprises”, are not intended to exclude other additional components or integers that may be incorporated as part of the invention.

1. A valve system comprising:
a valve body having at least a first port and a second port;
a valve member located within said valve body and operably movable between a first position at which a part of the valve member seals said first port, and a second position in which said first port is fully open and unobscured by said valve member part; and
an operating mechanism for moving the valve member between the first and second positions, the operating mechanism adapted to be mounted adjacent the valve body and comprising:
a transmission member operatively connected with the valve member; and
an actuator member operable to effect movement of the transmission member, whereby rotary movement of the actuator member effects independent linear and rotational movements of the transmission member causing corresponding linear and rotational movements of the valve member to move it from the first position to the second position.

2. A valve system according to claim 1, wherein the operating mechanism includes a housing which is mounted adjacent the valve body, and wherein the transmission member and the actuator member are located within said housing.

3. A valve system according to claim 1 or claim 2, wherein movement of the valve member from the first position to the second position includes an initial linear movement of the valve member out of sealed engagement at the first port, followed by a rotational movement.

4. A valve system according to claim 3, wherein the rotational movement of the valve member is through an angle of approximately 90 degrees.

5. A valve system according to any one of claims 1 to 4, wherein the transmission member has one or more shaped portions for interaction with one or more abutment surfaces in the housing, and wherein the linear movement of the transmission member results from reaction forces between the shaped portion(s) of the transmission member and the abutment surface(s) within the housing upon rotary movement of the actuator.

6. A valve system according to claim 5, wherein the one or more shaped portions are provided at a periphery of the transmission member, and wherein the one or more abutment surfaces are provided at the inner sides of the housing.

7. A valve system according to claim 6, wherein the abutment surfaces at the inner sides of the housing include a surface presented by at least a first inwardly projecting element, and wherein the shaped portions at the periphery of the transmission member include at least one recess or shoulder adapted to receive or abut the first projecting element when the valve member is in the first position.

8. A valve system according to claim 7, wherein the abutment surfaces at the inner sides of the housing include a surface presented by a second inwardly projecting element, and wherein said recess or shoulder is adapted to receive or abut that second projecting element when the valve member is in the second position.

9. A valve system according to any one of claims 1 to 8, wherein the transmission member is rigidly connected to the valve member at one side thereof, the other side having a pin protrusion, and wherein the rotary actuator member is adapted to operably engage the transmission member at the pin protrusion for moving the valve member between the first and second positions.

10. A valve system according to claim 9, wherein the actuator member includes a hole or aperture within which the pin protrusion is received, the inner sides of said hole or aperture adapted to engage the pin protrusion for moving the valve member between the first and second positions.

11. A valve system according to claim 10, wherein the pin-receiving hole or aperture in the actuator member is substantially larger than the pin protrusion itself thereby providing the actuator member with a degree of “play” or room for movement without causing movement of the transmission member.

12. A valve system according to claim 11, wherein the actuator member is mounted on a shaft, via which rotary motion is imparted to the actuator member.

13. A valve system according to any one of claims 1 to 12, wherein the actuator member and the transmission member are each formed from plate material, and lie adjacent one another within the operating mechanism housing for movement in substantially parallel planes.

14. A valve system according to any one of claims 1 to 13, wherein the first port is fully unobscured when the valve member is in the second position.

15. A valve system according to any one of claims 1 to 14, wherein the valve member is adapted to provide fluid communication between the first and the second ports when the valve member is in the second position.

16. A valve system according to claim 15, wherein the valve member includes a closed or blind face for sealing against a valve seat at the first port when the valve member is in the first position, and an open pipe segment adapted to provide fluid communication between the first and the second ports when the valve member is in the second position.

17. A valve system according to claim 16, wherein the first port of the valve body is an outlet port, and the second port is an inlet port.

18. A valve system according to claim 17, wherein the open pipe segment has substantially the same dimensions as the flow openings of the inlet and outlet ports.

19. A valve system according to any one of claims 1 to 14, wherein the second port is sealed when the valve member is at said second position.

20. A valve system according to claim 19, wherein each of the first and second ports of the valve body are outlet ports, and wherein the valve member is movable between the first and second positions to divert flow from a third inlet port of the valve body to either one of the first or second outlet ports.

21. A valve system according to claim 20, wherein movement of the valve member from the first position to the second position comprises an initial linear movement of the valve member out of sealed engagement at the first port, followed by a rotational movement of the valve member and then a further linear movement into sealed engagement at the second port.

22. A valve system according to claim 21, wherein the valve member includes a disc-shaped plug for sealing against a valve seat at each of the first and second outlet ports in the first and second positions, respectively.

23. A valve system according to claim 22, wherein the valve seat at each of the first and second outlet ports includes a circular bevelled edge.

24. A valve system according to any one of the preceding claims, further including a locking mechanism to lock the valve member in a mid-position between the first and second positions, the locking mechanism including:
a movable locking pin biased into contact with the transmission member; and a slot provided in said transmission member for receiving the locking pin;
wherein the locking pin is designed to enter the slot and thereby lock the transmission member against further movement.

25. A valve system according to claim 24, wherein the locking mechanism includes disabling means adapted to hold the locking pin in a retracted state to prevent it from entering the locking slot in the transmission member.

26. A diversion valve system comprising:
a valve body having at least a first outlet port and a second outlet port;
a valve member located within said valve body and operably movable between a first position in which it seals said first outlet port, and a second position in which it seals said second outlet port and said first outlet port is fully open; and
an operating mechanism for moving the valve member between the first and second positions to divert flow from an inlet port of the valve body to either one of the first or second outlet ports;
wherein the operating mechanism is adapted to be mounted adjacent the valve body and comprises:
a housing;
a transmission member within the housing, the transmission member being operatively connected with the valve member; and
an actuator member within the housing operable to effect movement of the transmission member, whereby rotary movement of the actuator member effects independent linear and rotational movements of the transmission member within the housing causing corresponding linear and rotational movements of the valve member moving it from the first position to the second position.

27. A diversion valve system according to claim 24, wherein movement of the valve member from the first position to the second position comprises an initial linear movement of the valve member out of sealed engagement at the first outlet port, followed by a rotational movement of the valve member and then a further linear movement into sealed engagement at the second outlet port.

28. A clear bore valve system comprising:
a valve body having at least a first outlet port and a second inlet port;
a valve member located within said valve body and operably movable between a first position in which it seals said first outlet port, and a second position in which said first outlet port is fully open providing unobstructed fluid communication between the first and the second ports; and
an operating mechanism for moving the valve member between the first and second positions to selectively open or close a passage for fluid flow through the valve system;
wherein the operating mechanism is adapted to be mounted adjacent the valve body and comprises:
a housing;
a transmission member within the housing, the transmission member being operatively connected with the valve member; and
an actuator member within the housing operable to effect movement of the transmission member, whereby rotary movement of the actuator member effects independent linear and rotational movements of the transmission member within the housing causing corresponding linear and rotational movements of the valve member as it moves from the first position to the second position.
